(19) United States
(12) Patent Application Publication
(10) Pub. No.: US 2004/0015811 A1
(43) Pub. Date: Jan. 22, 2004

(54) Method and apparatus for the creation of software applications

(76) Inventors: Nathanial X. Freitas, New York, NY (US); Shane Conneely, New York, NY (US); Will Meyer, New York, NY (US); Jonathan Oakes, New York, NY (US); James Venturi, New York, NY (US); Evan Simeone, New York, NY (US); Scott Gross, New York, NY (US)

Correspondence Address: PEPPER HAMILTON LLP, ONE MELLON BANK CENTER, 500 GRANT STREET, 50TH FLOOR, PITTSBURGH, PA, 15219, US

(21) Appl. No.: 09/874,378

(22) Filed: Jun. 6, 2001

Related U.S. Application Data
(60) Provisional application No. 60/268,872, filed on Feb. 16, 2001.

(51) Int. Cl. G06F 9/44

(52) U.S. Cl. 717/100; 717/167

(57) ABSTRACT

The present invention provides a method and apparatus for the creation of software applications that enable the interaction between a mobile business user with a wireless device or handset to interact with functions and information stored in a remote networked server. The wireless device may use either a micro-browser application, which supports some known markup language, or a more powerful “smart” or thick client application. The interaction between device and server is facilitated by wireless infrastructure and middleware (which could include the ThinAir Server™). The server supports the storage and retrieval of data either through some direct access method such as Structured Query Language (SQL) or a more complicated programmatic interface. Through the use of a software development kit and specific techniques and methods described, a software developer can create effective, efficient wireless applications which employ the components mentioned above.

### PRIORITY

The following application claims priority from U.S. Provisional Patent Application Serial No. 60/268,872, filed Feb. 16, 2001, incorporated herein by reference.

### COMPUTER PROGRAM LISTING APPENDIX

A computer program listing appendix having the following files: com.thinairapps.tag.wml; com.thinairapps.tag; com.thinairapps.tag.html; com.thinairapps.tag.hdml; WAPDevice.java; WAPDeviceProfile.java; UPWAPDeviceProfile.java; UPWAPDevice.java; TellMeDeviceProfile.java; TellMeDevice.java; PocketIEDeviceProfile.java; PocketIEDevice.java; PalmVIIDeviceProfile.java; PalmVIIDevice.java; OmniSkyDeviceProfile.java; OmniSkyDevice.java; NokiaWAPDeviceProfile.java; NokiaWAPDevice.java; HTMLDeviceProfile.java; HTMLDevice.java; HDMLDeviceProfile.java; HDMLDevice.java; GoWebRIMDeviceProfile.java; GoWebRIMDevice.java; GowebPalmDeviceProfile.java; GoWebPaImDevice.java; EricssonWAPDevice.java; AvantGoDeviceProfile.java; AvantGoDevice.java; Getting Started the Hello World Sample Connector; DeviceDetective a.k.a. Inspector Gadget Sample Connector; Database Connector Sample Connector; Wireless Forms Sample Connector; Tic Tac Toe Sample Connector; Webscraper Sample Application; ThinAir Distributed File Store Provider Microspft Windows NT/2000 Distribution, Version 1.1; TextFile Sample Groupware Provider; Send Email Sample Groupware Connector; GetItems Sample Groupware Connector; CustomItem Sample Groupware Connector; WML Rendering Sample Connector; Profile Management Sample Connector; Session Management Sample Connector; Logging Connector Sample Connector; HTML Rendering Sample Connector; PortalConnector.java; and CRMConnector.java; accompanies this application, the disclosure of which is incorporated herein by reference. This appendix contains material which is subject to copyright protection. The copyright owner has no objection to the reproduction by anyone of the patent document or the patent disclosure as it appears in the Patent and Trademark Office patent file or records, but otherwise reserves all copyright rights. The following notice applies to the software and data as described below and in the drawings hereto: Copyright 2001 ThinAirApps, Incorporated, All rights reserved.

### FIELD OF THE INVENTION

The present invention relates to a method and apparatus for the creation of software applications. More particularly, the present invention relates to a software development tool kit used to facilitate access to tools and services for developing applications on a server. The present invention further relates to a method and apparatus for the creation of software applications that enable the interaction between a mobile wireless device with functions and information stored in a remote networked server.

### BACKGROUND OF THE INVENTION

The deployment and usage of wireless devices, including both mobile phones and personal digital assistants (“PDAs”), is growing at a 66% CAGR domestically and 80% globally. By 2005, it is estimated that over one billion wireless devices will be in use worldwide. PDAs and mobile phones are increasingly converging with PDAs becoming wirelessly enabled and mobile phones providing smart functionality such as personal information management. This new class of smart hand-held devices is estimated by IDC to grow to a $19 billion global market by 2004 with shipments of over 45 million devices in that year.

Wireless devices vary widely in price, capabilities, and coverage. Developers may find that settling on a single device is impossible because of the diverse needs of their users. Technically, there are several key factors that may affect which device is best suited for the intended application, and thereby influence your design approach:

Screen size and resolution: Ensuring there is enough screen real estate to present a reasonable user interface.

Markup language richness: Some devices support a variant of HTML, with an application “shell” and certain resources, such as icons, resident on the device (e.g. a PQA on a Palm OS™ device). Other devices use multiple card-based markup languages, allowing for device-side manipulation of data through variables and scripting.

Input mechanism: If an application will require extended text input, be sure that the device provides a keyboard, stylus, or other mechanism that is comfortable to a user. If there is a need to support phones that have no such mechanism, it must be determined how much data entry can be accomplished by letting a user choose from a list.

Native application capability: Some wireless devices support only markup-language (browser-type) applications, while others are fully programmable. If an application will require complex processing on the device itself, make sure it is of the programmable type. (In many cases, though, processing should be offloaded to the server; the wireless application should be kept as simple as possible.)

In developing software for these emerging and growing wireless devices, tradeoffs will need to be made. For example:

Security: Will the solution provide a security model that relies upon the client device to secure data through screen passwords and data encryption? Or, will real-time authentication against a server or directory be possible? If point-to-point device communication is involved how will access to application data be granted?

Latency: Does the combination of device and wireless network provide for an experience that is quick and responsive, or that is perceived as slow, forcing the user to wait for a response? Can network transactions be fast enough that latency is not an issue?

Delivery: Will the delivery of data to a user be initiated by a server, or by the user, or by the device? Is instant notification and alerting important to the user and application, or potentially annoying and intrusive? What model does the target device and network hardware support?

Connectivity: What is the likelihood of sufficient wireless network coverage within the primary geographic location of a user? Does the device or application require a user to have an active network connection? Does point-to-point connectivity between devices play a factor?

Accessibility: Is the nature of the application such that regular synchronization of state between a desktop or server is sufficient, or does the application model include the need for complex transactions involving a data scope larger than what would be “synched” onto a device? Is synchronization not necessary because the quality of connectivity and minimal latency?

It can be viewed that these tradeoffs are bands in a spectrum much like the wireless network frequency spectrum.

As depicted in FIG. 1, the bands of the spectrum represent different variables 10 to consider when building a wireless or mobile application. For every application, a horizontal slider 12 is moved through the band to choose where a particular application falls in the spectrum. Each application requires a different combination of variables.

For example, there are three models or mechanisms that wireless applications currently employ to transport data to a wireless device: Pull, Page (or Notification), and Push. The goal of pull-based methods is to provide the most up-to-date information and data. It is also useful for searching and retrieving web pages, documents, media assets, etc. The pull approach may also be used to query and retrieve data off of other client devices, which have the request pushed to them. Paging is important in point-to-point communication. This is essentially short or instant messaging between client devices in order to relay a small bit of timely information. Presence and Location play a key part in this type of usage model. A Push mechanism should be used as a means of transparent synchronization of certain data within background processes of client device software. This may be status information, message headers, new client software, or any data needed in an offline, disconnected context.

There are many other variables that could be put into play such as network bandwidth, device operating system, processor capability, battery power, geographic mobility, and network usage costs. The criteria identified above are a core subset essential to wireless application design. It would therefore be desirable if a method and apparatus for developing wireless application software were available which would make the design of such software more efficient.

### SUMMARY OF THE INVENTION

The foregoing desires have been satisfied to a great extent through use of the wireless software development kit (“SDK”) of the present invention. The wireless software development kit of the present invention gives access to tools and services for the purpose of developing applications on the ThinAir Server™ and other Application Server products. The SDK expands the possibilities for wireless communication and allows the support of multiple devices and protocols. Java®) developers can use the toolkit to create wireless applications for enterprise data stores and systems using modular plug-ins customized to existing operating systems and applications. Using the SDK there is no need to learn a new device language or wireless protocol.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a representation of a wireless application “spectrum”.

FIG. 2 is a block diagram representation of the basic request flow showing devices that can be linked using the software development kit of the present invention.

FIG. 3 is a flowchart representing the intra-application routing process of the present invention.

FIG. 4 is a diagram representing an overview of wireless application solutions for mobile business use of the present invention.

FIG. 5 is a block diagram of the application of a model view controller paradigm of a preferred embodiment of the present invention.

FIG. 6 is a block diagram representing an overview of the wireless applications built, using the software development kit, and deployed on a server platform of a preferred embodiment of the present invention.

### DETAILED DESCRIPTION OF PREFERRED EMBODIMENTS OF THE INVENTION

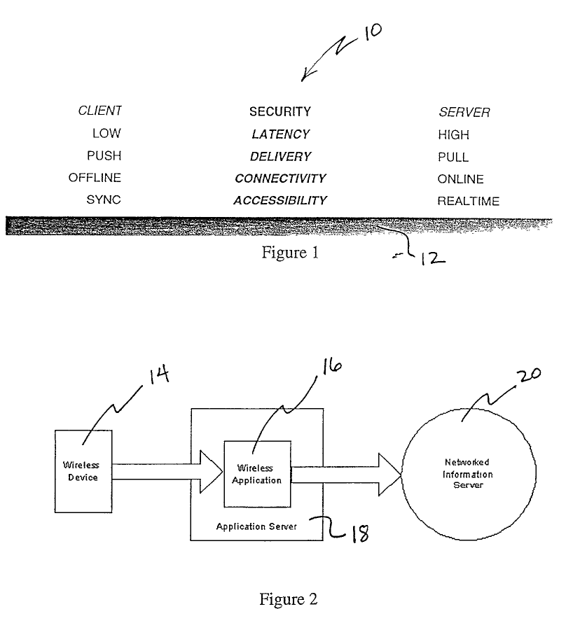

Referring now to the figures wherein like reference numerals indicate like elements, in FIG. 2 there is shown a block diagram of the basic request flow between wireless devices 14, wireless applications 16 on top of application servers 18, and networked information servers 20.

In an exemplary embodiment, the server of U.S. patent application Ser. No. 09/759,204 (the “ThinAir Server™”), the disclosure of which is incorporated herein by reference, can be used as the application server 18. This application server is an open, extensible platform for developing and delivering applications to a variety of wireless devices, from Palm OS® devices to WAP-enabled handsets. Implemented in 100% Pure Java, the ThinAir Server™ architecture manages the communication details of each device automatically, allowing developers to concentrate on writing the business logic of their applications.

An application for the ThinAir Server™ is composed of one or more components called Connectors. Each Connector is a Java program written on top of the ThinAir Platform™ API that implements the application for a set of device types. The server provides each Connector with several run-time services, including device identification, session management, and a persistent data store for user profile information, that satisfy requirements common to most applications.

For more complex applications, a Connector can be complemented with a data-acquisition component called a Provider. By implementing a Provider, developers can delegate the interaction with a remote data store to a separate module, allowing the Connectors to focus exclusively on communication with devices. The ThinAir Server™ supports Providers running within the same process, as separate processes on a single machine, or as fully distributed components on multiple servers within a public network. These options allow an organization to configure its applications for optimal scalability and fault-tolerance.

Groupware Access for ThinAir Server™ is an example of a full-featured application leveraging the capabilities of the ThinAir Server™. The Groupware application is composed of Connectors for Palm™ Connected Organizers, WAP-enabled phones, and HTML web browsers, including Pocket PC™. The standard ThinAir Server™ installation includes Providers for POP, IMAP, Microsoft Exchange™, and Lotus Domino® Groupware servers. Each Connector can communicate with any of these Providers to obtain Groupware data.

Finally, the ThinAir Server™ architecture employs full SSL services (including HTTPS) to protect communication between devices, Connectors, and Providers. This and other features, including a fully encrypted user profile store, ensure that ThinAir Server™ meets the highest industry standards for security within a distributed system.

Because the ThinAir Server™ platform is 100% Java® an application can be deployed just about anywhere. The server's architecture enables you to distribute components across multiple machines, allowing for load balancing, creating redundancy, and coexistence with complex network and firewall configurations. In addition, the ThinAir Server™ supports 128-bit RSA™ SSL encryption. Tag Libraries handle the rendering intricacies of common device markup languages by employing an object-oriented approach to displaying content, messages, and forms. Through the Groupware Providers applications can be easily built that access Microsoft Exchange Server® or Lotus Domino Server. Providers can also be built that leverage the distributed, secure framework of ThinAir Server™ to enable access to remote data.

The types of application that can be built on the ThinAir Server™ Platform using the SDK include order placement, inventory tracking, customer information, messaging, and mCommerce. View and manipulate data stored in ODBC and JDBC enabled databases, XML document, and Microsoft Outlook and Lotus Notes forms. Components and technologies supported include JavaBeans™ and Servlets, to JINI and XML.

The ThinAir Server™ Platform includes profiles for most popular wireless devices, allowing an application to decide which types of devices it will support, and informing that application of the specific device parameters accessing each request. WML 1.1, HDML 3.0, and Palm VII HTML are supported for easily delivering data to target devices.

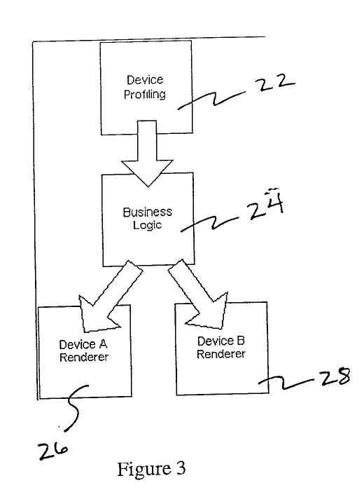

In FIG. 3 there is shown a flowchart of the intra-application routing process with the steps of device profiling 22 and business logic 24 which can branch off to either a device A Renderer 26 or a device B Renderer 28. This demonstrates that the basic principal that business logic is unified while the presentation of that logic, and its resulting data, can be communicated through multiple channels. This improves the capability of the developer to leverage their existing software infrastructure.

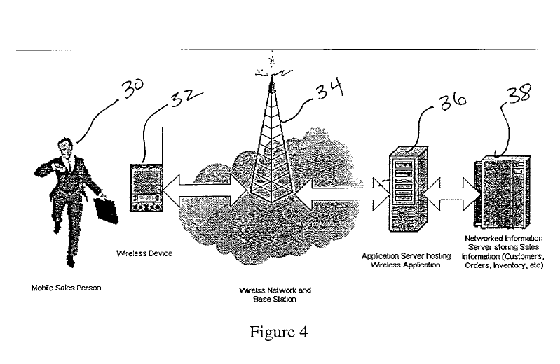

Referring to FIG. 4, in operation, wireless devices will be useful in many different applications for providing access to widely varying data. For example, a sales person 30 may utilize a PDA, Blackberry pager or other wireless device 32 to access sales information by communicating over a wireless network 34 to a wireless application server 36 that is in turn connected to a networked server containing the sales information. The basic principal then is that for the Application Class (Groupware, Sales Force, Enterprise Resource Management, etc) define a lightweight and universal “mobile” definition of the data types and functions which works best for the wireless solution, yet can still interact with a variety of network information stores and enterprise applications. The communication between the wireless software application's server-side components and the legacy application or data is performed using standard, well-known protocols and technology. The communication between the server components and the wireless software application's device-side components must use new, more efficient protocols and technology. The methods and functions of this invention improve the capability to develop those new protocols and technology.

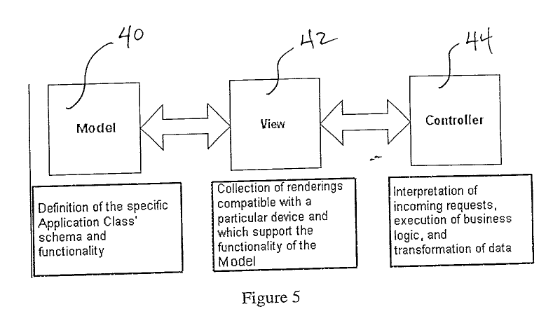

In FIG. 5 there is shown one means to understand the present invention for wireless application development in terms of the traditional Model/View/Controller paradigm. In object-oriented programming development, model-view-controller (MVC) is the name of a methodology or design pattern for successfully and efficiently relating the user interface to underlying data models. The MVC pattern is widely used in program development with programming languages such as Java, Smalltalk, C, and C++.

The MVC pattern has been heralded by many developers as a useful pattern for the reuse of object code and a pattern that allows them to significantly reduce the time it takes to develop applications with user interfaces. The model-view-controller pattern proposes three main components or objects to be used in software development:

A Model, which represents the underlying, logical structure of data in a software application and the high-level class associated with it. This object model does not contain any information about the user interface.

A View, which is a collection of classes representing the elements in the user interface (all of the things the user can see and respond to on the screen, such as buttons, display boxes, and so forth).

A Controller, which represents the classes connecting the model and the view, and is used to communicate between classes in the model and view.

Model 40

The best example of the inventions usage of Model 40 is with the ThinAir™ Groupware API definition. The process of creating it entails an analysis of all commercial product's Groupware DataStore Schema and deciding the proper subset that would 1) capture the capabilities of all the different products in the market the user planned to interface with 2) be lightweight enough to communicate state over a low-bandwidth, high-latency wireless network and 3) satisfy the end-user in both simplicity and functionality.

View 42

Wireless applications come in one of two flavors. Either a “Smart Client” binary that executes on the wireless device, and that is written in C, C++, J2ME, or Visual Basic, and built on top of client-side Application Libraries, or a browser-targeted application, built using server-side APIs and Tag Libraries, 42.

Controller 44

The ThinAir™ Connector handles the interpretation of incoming requests and transformation of the Model 40 into an acceptable format. Connectors are server-side components which manage logic and flow, and the client-side Network Application Libraries perform this functionality. For example, the ThinAir™ Groupware Library and associated API (TAGroupware) define both the flow and schema for interacting with a remote groupware data store, such as Microsoft Exchange™ or Lotus Domino®.

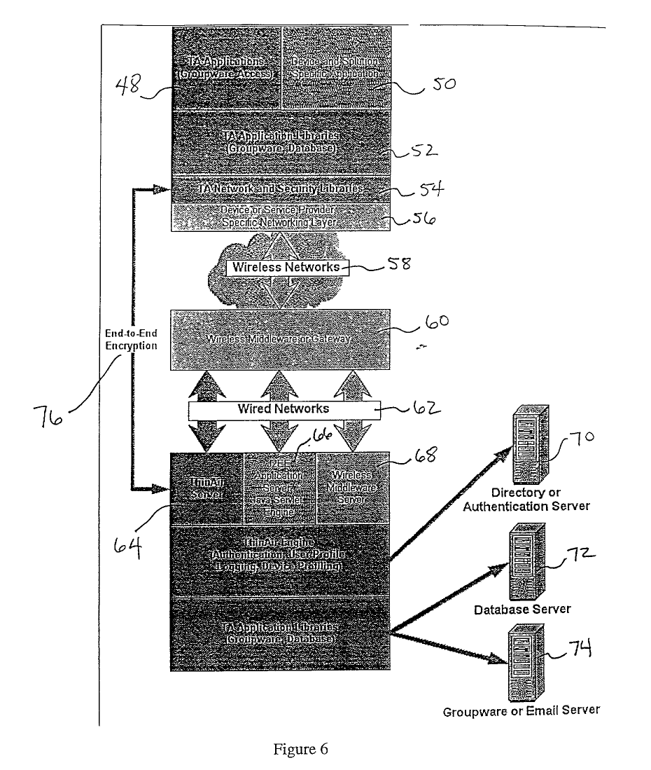

In FIG. 6 there is shown applications built using the software development kit being deployed on the networked server platform. Applications 48 include groupware access, device and solution specific applications 50, application libraries 52, network and security libraries 54 and a device or service provider specific networking layer 56. The server platform includes wireless networks 58, wireless middleware or gateways 60, wired networks 62, directory/authentication server 56, database server 58 and groupware or email server 60, and a server 52. The networked server platform 70 is end-to-end encrypted. The server includes a ThinAir™ server 64, wireless middleware server 68, a J2EE application server 66, and a Java® servlet engine.

The two most important features of the device library are the ability to detect what type of device is making a request, and then to query a device object to determine specific characteristics of the requesting device. Therefore, in writing Device objects, the first step is to decide, based upon the information provided to the ThinAir Server™ in the HTTP request headers, how to identify a specific device type. Typically, checking the User-Agent or Accept header of the request for specific strings can do this. For example, the HTMLDeviceProfile checks for the presence of the string “Mozilla” in the User-Agent header, as well as the string “text/html” in the Accept header. If either of these strings are present, the requesting device is of type HTML. Care must be taken to ensure that whatever means used to identify a device type will be sufficient for all possible requests of the device type, but will not accept any device of any other type.

Once a means of identifying the device type based upon the HTTP request has been confirmed, the next step is to decide what properties to encapsulate into the Device object representing the new device. For example, the screen size of the device, or what languages the device supports may be included.

There are two primary ways to decide what properties to include: by inspecting the headers included with the HTTP request, or by examining any device documentation supplied by the device manufacturer for specific device models. When a request is received, there are typically a number of HTTP headers that specify certain device specific parameters. For example, when an HTML browser makes a request, it sends along the headers ACCEPT-LANGUAGE, ACCEPT-ENCODING, HOST, and CONNECTION, which all contain information specific to the machine where the browser is running. When an HTMLDevice is created, there are four device properties corresponding to these headers, which are initialized to the values in the HTTP headers.

If the user desires to include information that cannot be found in the request headers, the user may do so by detecting the specific device model making a request, and then initializing device properties using information found in device documentation. This method may provide a more complete expression of a device, but may be more difficult due to the necessity of detecting a device's model number, as well as posing a larger risk of Device objects containing outdated information.

An example of programming for determining the type of device making an HTTP request is provided below:

public boolean isRequestFromDevice (ServletRequest req)
{
if (super.isRequestFromDevice (req))
{

```
HttpServletRequest request = (HttpServletRequest) req;
String accept = request.getHeader(“Accept”);
String userAgent = request.getHeader(“User-Agent”);
  return ( ((userAgent != null) && (userAgent.indexOf(“Mozilla”)
  >= 0)) | |
```

((accept != null) && (accept.indexOf(“text/html”) >= 0)) );

}

return false;

}

Wireless Forms Application

The goal of this application is to provide an example of an application that interacts with a JDBC-accessible relational database. Forms and Views are displayed in both HTML and WML, allowing the user to update and query data in a remote database from their wireless device. Wireless Forms Applications are defined in a simple XML document which conforms to the following framework (there is no DTD defined):

The following is an example Application definition:

```
<application name=“User Manager”>
  <database>
    <dsn>jdbc:odbc:sample_app</dsn>
    <login>user1</login>
    <password>password</password>
  </database>
  <views>
    <view name=“Users”>
      <query>SELECT login AS Users, password AS Pwd
      FROM users</query>
    </view>
  </views>
  <forms>
    <form name=“New User”>
      <query>insert into users (login, password) select ‘$lgn’,
      ‘$pwd’</query>
      <mappings>
      <display>
```

```
<input>UserName</input>
  <field>lgn</field>
  <type>text</type>
```

```
      </display>
      <display>
```

```
  <input>Password</input>
  <field>pwd</field>
  <type>password</type>
```

```
      </display>
      </mappings>
    </form>
  </forms>
</application>
```

Below is the code for the “handle” method of the Wireless Forms connector. It demonstrates the use of the Device object as a means of creating specific Renderers to handle the specific rendering for that device class. This application allows for rendering to occur either in the Wireless Markup Language or Hypertext Markup Language formats.

public void handle (Properties req, Device device, OutputStream out)

{

//extract current action using defined variable name constant
String action = req.getProperty(ACTION_ARG);
//init object used to store output from renderering
String output = null;
//init the renderer superclass
ApplicationRenderer renderer = null;
//based on the device type, determine which subclass of
//ApplicationRenderer to use. Since some WAP devices also
//supports HTML, we will specifically look for WAP suport first
if (device instanceof WAPDevice)
{

//its a WAP device, so create a WML Renderer
renderer = new WMLApplicationRenderer ( );

}
else if (device instanceof HTMLDevice)
{

//its a HTML deice, so create an HTML Renderer
renderer = new HTMLApplicationRenderer ( );

}
//if the action is NULL or is the default APP_ACTION
//get the list of available applications
if (action == null || action.equals(APP_ACTION))
output = wf.getApplications (renderer);
//the action tells the server to reload application definitions

```
  else if (action.equals (RELOAD_ACTION))
  {
```

```
try
{
  wf.init(App_DIR, DB_DRIVER);
  output = wf.getApplications (renderer);
}
catch (Exception e)
{
```

System.err.println (“WirelessFormsConnector.handle:

error on WirelessForms init: “ + e);

}

}

//retrieve and render a Menu, which display Forms and Views, for a
specific Application

else if (action.equals)MENU_ACTION))

output = wf.getMenu(req.getproperty(App_ARG), renderer);
//retrieve and render a View (essentially a JDBC ResultSet)

else if (action.equals(VIEW_ACTION))

output =

wf.getView(req.getproperty)App_ARG),
req.getProperty(ITEM_ID),req.getProperty(KEY), renderer);

```
  //
  else if (action.equals)FORM_ACTION))
output =
```

wf.getForm(req.getproperty(APP_ARG),req.getProperty(ITEM_ID),
renderer);

```
  //insert data into a tahie, and display a confirmation
  else if (action.equals(INSERT_ACTION))
```

{

output = wf.insertEntry

(req.getProperty(App_ARG),req.getProperty(ITEM_ID),req, renderer);

```
  }
  //write the output to the OutputStream via a PrintWriter
  Printwriter ps = new PrintWriter(out);
  ps.println(output);
  ps.flush( )
  ps.close( );
```

}

This method “renderForm ( )” from the WMLApplicationRenderer class used in the sample above, demonstrates the rendering of the Application and Wform objects into specific markup langague viewable on a Wireless Application Protocol (WAP)-enabled device.

public String renderForm (Application app, WForm form)

{

java.util.Properties props = form.getDisplayMap( );
Enumeration keys = props.keys( );
String key = null, label = null;

java.util.Properties urlP = new java.util.Properties( );
urlP.put (“ap”,app.getName( ));
urlP.put (“a”,INSERT_ACTION);
urlP.put (“i”,form.getName( ));
MultipleInputCard mic = new MultipleInputCard (“c1”,form.getName( ));
LabeledInput[ ] li = new LabeledInput [props.size( )];

```
  int i = 0;
  while (keys.hasMoreElements ( ))
```

{

key = (String)keys.nextElement( );

label = (String)props.get(key) + “:”;
li[i++] = new LabeledInput(key,label);
urlP.put(key, “$”+key);

```
  }
  String url = URLBuilder.buiidWapUrl (“?”,urlP,true);
  mic.buildCard (url,“Submit”,li,Go.METHOD_GET);
```

WMLTagDocument deck = new WMLTegDocument( );

deck.addCard(mic);

return deck.render ( );
}

The above description and drawings are only illustrative of preferred embodiments which achieve the objects, features, and advantages of the present invention, and it is not intended that the present invention be limited thereto. Any modification of the present invention which comes within the spirit and scope of the following claims is considered to be part of the present invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of designing wireless applications on an application server platform for wireless data, comprising the steps of:
using a software development kit to define custom device profiles; and
detecting said profiles to determine the type of wireless device or browser making an incoming request to said server.

2. Apparatus for performing the method of claim 1.
